(19) United States
(12) Patent Application Publication
(10) Pub. No.: US 2025/0077201 A1
(43) Pub. Date: Mar. 6, 2025

(54) METHOD FOR AUTOMATICALLY ANALYZING A COMPUTER PROGRAM

(71) Applicant: Robert Bosch GmbH, Stuttgart (DE)

(72) Inventors: Martin Ring, Lossburg (DE); Aaron Ujaque Hurley, Heilbronn (DE); Philipp Gmaehle, Obersulm (DE)

(21) Appl. No.: 18/788,667

(22) Filed: Jul. 30, 2024

(30) Foreign Application Priority Data
Sep. 6, 2023 (DE) 10 2023 208 591.7

(51) Int. Cl. G06F 8/41

(52) U.S. Cl. CPC G06F 8/43

(57) ABSTRACT

A method for automatically analyzing a computer program. The method includes generating intermediate representation code including a sequence of intermediate representation instructions by decompiling binary code of the computer program, generating one or more intermediate representation code strings from the sequence of intermediate representation instructions, searching for reference intermediate representation code strings of a plurality of reference intermediate representation code strings in the one or more intermediate representation code strings by means of a string kernel search, wherein each reference intermediate representation code string belongs to a program component, and ascertaining the program components to which the reference intermediate representation code strings found in the one or more intermediate representation code strings by means of the string kernel comparison belong as the program components present in the computer program.

### CROSS REFERENCE

The present application claims the benefit under 35 U.S.C. § 119 of German Patent Application No. DE 10 2023 208 591.7 filed on Sep. 6, 2023, which is expressly incorporated herein by reference in its entirety.

### FIELD

The present invention relates to a method for automatically analyzing a computer program.

### BACKGROUND INFORMATION

A manufacturer of a programmable device comprising associated software is responsible for its correct functioning and must therefore have knowledge of the software it contains and what possible vulnerabilities may exist. However, a software development team often does not have complete knowledge of the source code of the software because it uses third-party program components that are precompiled (e.g. certain program libraries). Efficient approaches for analyzing software starting from its binary code are therefore desirable.

The dissertation “Comparison of Compiler's Intermediate Representations and Input/Output Access Patterns with String Kernels” by Raul Ernesto Torres Carvajal, University of Hamburg, 2018, hereinafter referred to as Reference 1, describes the application of string kernel search to compiler intermediate representations.

### SUMMARY

According to various example embodiments of the present invention, a method for automatically analyzing a computer program (i.e., in particular, ascertaining the program components present in a computer program (to be examined and which is present in a compiled version, i.e. binary code)) is provided, the method comprising:
generating intermediate representation code comprising a sequence of intermediate representation instructions by decompiling binary code of the computer program;
generating one or more intermediate representation code strings from the sequence of intermediate representation instructions;
searching for reference intermediate representation code strings of a plurality of reference intermediate representation code strings (from a database) in the one or more intermediate representation code strings by means of a string kernel search, wherein each reference intermediate representation code string belongs to a program component (e.g. a function but possibly also a larger (sub) program); and
ascertaining the program components to which the reference intermediate representation code strings found in the one or more intermediate representation code strings by means of the string kernel comparison belong as the program components present in the computer program.

The method described above allows
code compiled by a compiler (binary code) and source code to be compared independently of the changes made by the compiler at compile time.
code similarities to be found, even if obfuscation techniques were used during compilation.
an SBOM (software bill of materials) to be generated for a computer program from its binary code.
software vulnerabilities to be found that are stored, for example, in a CVE (Common Vulnerabilities and Exposures) database.
analysis of the final binary code to be guaranteed. Because the binary code is used as a test object, all possible vulnerabilities contained in the source code or added during compilation by compiler changes, options and influences of the target architecture are included in the analysis by default. This ensures that the analyzed binary code is the one that is used (e.g. contained in a delivered product).

Various exemplary embodiments of the present invention are specified below.

Exemplary embodiment 1 is a method for automatically analyzing a computer program as described above.

Exemplary embodiment 2 is a method according to exemplary embodiment 1, wherein the one or more intermediate representation code strings are a plurality of intermediate representation code strings generated by combining subsequences of the sequence of intermediate representation instructions into program code segments which each form a function, and wherein the reference intermediate representation code strings are searched for in each intermediate representation code string.

This makes it possible to ascertain whether a program code segment corresponds to a specific program component and to avoid program components being found incorrectly on the basis of code components which are distributed across a plurality of functions in the computer program.

Exemplary embodiment 3 is a method according to exemplary embodiment 1 or 2, comprising ascertaining security gaps in the computer program on the basis of the ascertained program components and information regarding security gaps in the ascertained program components.

For example, the program components to which the reference intermediate representation code strings belong may be marked, at least in part, as program components with security vulnerabilities. Thus, the method can be used to carry out a security check of the computer program.

Exemplary embodiment 4 is a method according to one of exemplary embodiments 1 to 3, wherein the one or more intermediate representation code strings are generated from the sequence of intermediate representation instructions at least partially by compensating for or taking into account obfuscation techniques.

For example, the strings can be generated in a special way by reversing or taking into account obfuscation techniques, so that even obfuscated (sub) sequences of intermediate representation instructions can be assigned to the reference intermediate representation code strings (and thus to the associated program components).

Exemplary embodiment 5 is a method according to one of exemplary embodiments 1 to 4, comprising ascertaining program components missing in the computer program on the basis of the program components ascertained to be present in the computer program.

In this way, security gaps or malfunctions that arise due to missing program components (e.g. error handling functions) can be found.

Exemplary embodiment 6 is a method according to one of exemplary embodiments 1 to 5, comprising controlling a robot device comprising the computer program depending on whether the program components ascertained to be present in the computer program correspond to a predetermined set of required and/or permissible program components.

This allows secure control to be achieved.

Exemplary embodiment 7 is a software analysis system which is configured to carry out a method according to one of exemplary embodiments 1 to 6.

Exemplary embodiment 8 is a computer program comprising instructions that, when the instructions are executed by a processor, cause the processor to carry out a method according to one of exemplary embodiments 1 to 6.

Exemplary embodiment 9 is a computer-readable medium which stores instructions that, when the instructions are executed by a processor, cause the processor to carry out a method according to one of exemplary embodiments 1 to 6.

In the drawings, similar reference signs generally refer to the same parts throughout the various views. The figures are not necessarily true to scale, with emphasis instead generally being placed on the representation of the principles of the present invention. In the following description, various aspects of the present invention are described with reference to the figures.

### BRIEF DESCRIPTION OF THE DRAWINGS

FIG. 1 shows a computer for the development and/or testing of software applications, according to an example embodiment of the present invention.

FIG. 2 shows a flowchart for the analysis of a computer program starting from its binary code using binary lifting and a subsequent string kernel search, according to an example embodiment of the present invention.

FIG. 3 shows a flowchart that represents a method for automatically analyzing a computer program according to one example embodiment of the present invention.

### DETAILED DESCRIPTION OF EXAMPLE EMBODIMENTS

The following detailed description relates to the accompanying figures, which show, by way of explanation, specific details and aspects of this disclosure in which the present invention can be executed. Other aspects may be used and structural, logical, and electrical changes may be performed without departing from the scope of protection of the present invention. The various aspects of this disclosure are not necessarily mutually exclusive, since some aspects of this disclosure may be combined with one or more other aspects of this disclosure to form new aspects.

Various examples are described in more detail below.

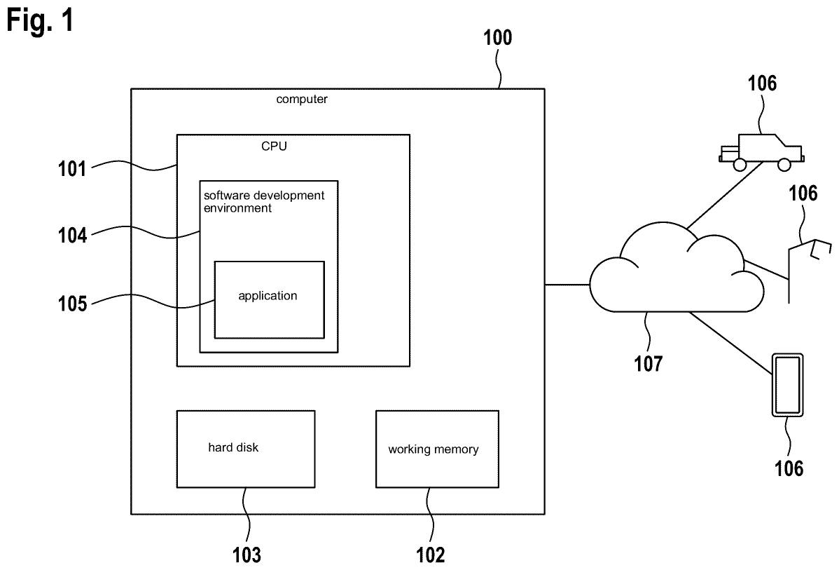

FIG. 1 shows a computer 100 for developing and/or testing software applications.

The computer 100 comprises a CPU (central processing unit) 101 and a working memory (RAM) 102. The working memory 102 is used for loading program code, e.g., from a hard disk 103, and the CPU 101 executes the program code.

In the present example, it is assumed that a user (developer) intends to develop and/or test a software application using the computer 100.

For this purpose, the user runs a software development environment 104 in the CPU 101.

The software development environment 104 makes it possible for the user to develop and test an application (i.e. software) 105 for different devices 106, i.e. target hardware, such as embedded systems for controlling robot devices, including robot arms and autonomous vehicles, or also for mobile (communication) devices. For this purpose, the CPU 101 can run an emulator as part of the software development environment 104 in order to simulate the behavior of the particular device 106 for which an application is being or has been developed. If it is used only for testing software from another source, the software development environment 104 can also be regarded as or configured as a software testing environment.

The user can distribute the finished application to corresponding devices 106 via a communication network 107. Rather than via a communication network 107, this can also be done in another way, for example by means of a USB stick.

However, before this happens, the user should have knowledge of possible security gaps of the application 105 in order to prevent an insecurely functioning application from being distributed to the devices 106. This may also be the case if the user has not written at least part of the application 105 himself (but has, for example, adopted program parts from third-party providers, e.g. libraries). For example, for a Tier 1 supplier of an application (or device with associated software), the application consists of proprietary code (of the supplier), OSS (open source software) parts, and precompiled libraries from third parties. In particular, the case may arise that the user does not have the source code of the (entire) application, but only its executable code (i.e. the binary program), i.e. that the application (computer program) 105 is (at least in part) a black box computer program from the tester's point of view.

In the case that the user (or a development team) has not (completely) written the application 105 themselves, the starting point for the security check is the binary code of a computer program. According to various embodiments, an approach is described that allows for an analysis, in particular with regard to its security (which may also depend on whether all intended program components are present), starting from binary code.

The starting point for the analysis is thus a compiled code, which according to one embodiment is returned to its intermediate representation by binary lifting (this can be seen as part of reverse engineering). The intermediate representation is then converted into a character string. Finally, string kernel comparison algorithms are applied to find similarities between the generated string and, for example, a local (string) database with strings of reference program code. The reference program code can be considered as the program code of a program library (which can comprise source code from publicly available libraries, commercial libraries, or even program code previously written by the user in question (or a user group to which the user belongs)).

This approach finds code similarities (between the binary code and the database) even if the compiler made changes during compilation. Even if the source code was compiled for different architectures and optimization settings and obfuscation techniques were applied, the string kernel pattern search is able to find similarities between the binary code strings generated from the intermediate representation and the strings from the string database. By applying this string kernel approach, it is possible to detect whether certain code snippets or library functions are part of the analyzed binaries, for example to facilitate security and vulnerability management by creating a software bill of materials (SBOM). In addition, malware analysis can be performed by comparing the generated strings with known software that has been reported as vulnerable. For example, strings corresponding to the code contained in the (open) CVE (Common Vulnerabilities and Exposures) database can be included in the string database.

Some of the terms used herein are explained below:
Binary lifting is the technique of translating machine instructions into an intermediate representation.
Reverse engineering is the process of discovering the components and functionality of a program. The original software is recovered by analyzing the compiled code. Hackers use this technique to find vulnerabilities.
Code obfuscation refers to a set of techniques used to improve code security by hiding implicit values and obfuscating logic, making it more difficult to reverse engineer the compiled software and recover the original source code.
Obfuscation techniques are applied to the following areas of code: data, control flow and layout structure.
The intermediate representation acts as the central data structure of a compiler. Optimizations and analyses are applied to them. Intermediate representations thus serve as a connection point between the front-end and the back-end of the compiler.
The compiler is used to generate machine code from the source code. The front-end of the compiler takes the source code as input and creates an intermediate representation. This intermediate representation is then passed on to the back-end, which produces the target code (binary code) as the final result.
String kernels represent tree-like data structures that are treated as a set of consecutive weighted tokens.
The software bill of materials (SBOM) of a program (i.e. software) is a list of third-party and open source components that are part of the program code. SBOMs also contain licenses for those components, the component version used in the code, and the corresponding patch status.

According to various embodiments, as mentioned above, string kernel comparison methods (in the area of code similarity) are applied to generate an SBOM (e.g. completely, at least with respect to the list of program components) of a program from its binary code. This allows the security management of the program to be improved and automated.

Most third-party software components (i.e. “external” program components) are delivered as binary code, so that a developer or development team does not have access to the source code. Even within a manufacturer, it can happen that software libraries (i.e. “internal” program components) are transferred from one software management system to another without proper tracking. External software components are difficult to correctly identify and assign vulnerabilities to, but the same may be true for internal software components.

The approach described here allows the search for vulnerabilities in binary code without external assistance, thereby improving the knowledge of software risks and their security management. In addition, a developer can identify whether and which parts are missing in a deployed SBOM. String kernel search makes it possible to search for software components (especially source code components) starting from compiled binaries with a certain degree of uncertainty.

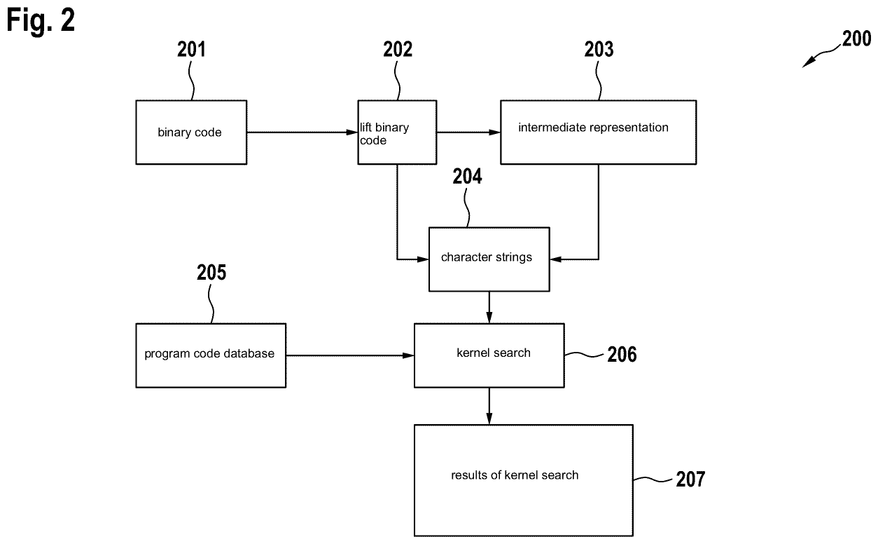

FIG. 2 shows a flowchart for the analysis of a computer program starting from its binary code using binary lifting and a subsequent string kernel search.

The starting point is binary code (e.g. a compiled binary file) 201 of a program to be examined, which is lifted to lifted binary code 202 by means of binary lifting. On the basis of the lifted binary code 202, an intermediate representation (IR) 203 can be generated. Character strings 204 are generated from these two sources (IR 203 and/or lifted binary code 202).

This generation of character strings is also carried out for program components that are to be detected in the compiled binary file 201 (if present therein), i.e. a program code database in string form 205 is generated. The set of program code for which the program code database contains 205 strings can be viewed as a program library (which contains software components (e.g. subprograms, functions, etc.) that are to be detected for an SBOM of the binary code therein or also known malicious program components or program components with vulnerabilities that are to be detected for the security analysis of the binary code therein). The strings for the program code database 205 can be generated from binary code of program components for which the program code database 205 is to contain strings, in the same way as for the binary file 201 (or alternatively from the source code of the relevant program component, if this is known). For example, known suspicious source code can be converted directly into an IR and strings or can be compiled first and then analyzed further from there (i.e. strings can be generated therefor analogous to the binary file 201).

Kernels can now be used in a kernel search 206 to search for program components in the program to be examined for which the program code database 205 contains strings.

Thanks to the uncertainty of the approach provided by the kernel search, it is possible, for example, to find comparable vulnerable code in the binary file 201 for known program components with vulnerabilities (for which the program code database contains 205 strings).

The results 207 of the kernel search 206 can be used in many ways, such as:
to generate an SBOM for the program to be tested: even if its source code cannot be accessed, known program components (e.g. from third-party software libraries) can be detected and listed.
to find vulnerable code segments on the basis of internal and external program components (e.g. code snippets) for which strings are contained in the database 205, even if code from third-party libraries was re-used for the program to be tested or internal libraries (i.e. program components of the same manufacturer as the program to be tested) were transferred between code databases and renamed.
to identify obfuscation: The uncertainty of the string kernel search makes it possible to identify program components from the database 205, even for certain classes of obfuscation.

A simple example of the processing shown in FIG. 2 is given below.

In this example, the source code of the program to be examined is:

```
#include<stdio.h>
int loop(int i) {
for(int a=0; a < i; a++) {
  printf(“%d \n”, a);
}
}
int main( ) {
  printf(“Start IDA Tracing\n”);
  int i=2; // change this to increase or decrease
the trace size
  int x=loop(i);
  printf(“Stop IDA Tracing \n”);
  return 0;
}
```

The binary code 201 of this program is:

| | | | | | | | | | | | | | | | |
|---|---|---|---|---|---|---|---|---|---|---|---|---|---|---|---|
| 01 | 00 | 02 | 00 | 25 | 64 | 20 | 0a | 00 | 53 | 74 | 61 | 72 | 74 | 20 | 49 |
| 44 | 41 | 20 | 54 | 72 | 61 | 63 | 69 | 6e | 67 | 00 | 53 | 74 | 6f | 70 | 20 |
| 49 | 44 | 41 | 20 | 54 | 72 | 61 | 63 | 69 | 6e | 67 | 00 | 01 | 1b | 03 | 3b |

The lifted binary code 202 is:

```
        ★★★★★★★★★★★★★★★★★★★★★★★★★★★★★★★★★★★★★★★★
        ★ FUNCTION ★
        ★★★★★★★★★★★★★★★★★★★★★★★★★★★★★★★★★★★★★★★★
          undefined main( )
```

| undefined | AL:1 <RETURN> | |
|---|---|---|
| undefined4 | Stack[−0xc]:4 local_c | XREF[2]: 0010119c(W), |

001011a3(R)

| | | |
|---|---|---|
| undefined4 | Stack[−0x10]:4 local_10 | XREF[1]: 001011ad(W) |

```
  main XREF[4]: Entry Point(*),
    _start:00101074(*), 00102058,
    00102110(*)
  55
  48 89 e5
  48 83 ec 10
```

| | |
|---|---|
| 48 8d 05 | = “Start IDA Tracing” |

75 0e 00 00

| | |
|---|---|
| 48 89 c7 | = “Start IDA Tracing” |
| e8 94 fe | int puts(char * _{——}s) |

```
  ff ff
  c7 45 fc
  02 00 00 00
  8b 45 fc
  89 c7
```

| | |
|---|---|
| e8 9c ff | undefined loop( ) |

```
  ff ff
  89 45 f8
```

| | |
|---|---|
| 48 8d 05 | = “Stop IDA Tracing” |

64 0e 00 00

| | |
|---|---|
| 48 89 c7 | = “Stop IDA Tracing” |
| e8 71 fe | int puts(char * _{——}s) |

```
  ff ff
  b8 00 00
  00 00
  c9
  c3
  //
  // .fini
  // SHT_PROGBITS [0x11c8 − 0x11d0]
  // ram: 001011c8-ram:001011d0
  //
        ★★★★★★★★★★★★★★★★★★★★★★★★★★★★★★★★★★★★★★★★
        ★ FUNCTION ★
        ★★★★★★★★★★★★★★★★★★★★★★★★★★★★★★★★★★★★★★★★
      undefined _fini( )
undefined AL:1 <RETURN>
```

| | |
|---|---|
| _{——}DT_FINI | XREF[3]: Entry Point(*), 00103e08(*), |
| _fini | _elfSectionHeaders::00000410(*) |

48 83 ec 08

The generation of the lifted binary code 202 comprises in particular decompiling the binary code 201 so that a sequence of intermediate representation instructions is generated. The lifted binary code 202 indicates which values refer to memory addresses and which refer to instructions, as well as which areas of the binary code 201 together form a function. For this purpose, intermediate representation instructions of subsequences of the sequence of intermediate representation instructions are grouped into program code segments, each of which forms a function.

The intermediate representation 203 (in this example p-code) has the form

```
                ★★★★★★★★★★★★★★★★★★★★★★★★★★★★★★★★★★★★★★★★
                ★ FUNCTION ★
                ★★★★★★★★★★★★★★★★★★★★★★★★★★★★★★★★★★★★★★★★
              undefined main( )
```

| undefined | AL:1 <RETURN> | |
|---|---|---|
| undefined4 | Stack[−0xc]:4 local_c | XREF[2]: |

0010119c(W),

| | | 001011a3(R) |
|---|---|---|
| undefined4 | Stack[−0x10]:4 local_10 | XREF[1]: |

001011ad(W)

| | |
|---|---|
| main | XREF[4]: Entry Point(*), |
| | _start:00101074(*), |

00102058,

00102110(*)

00101185 55

```
  $Ued00:8 = COPY RBP
  RSP = INT_SUB RSP, 8:8
  STORE ram(RSP), $Ued00:8
```

00101186 48 89 e5

RBP = COPY RSP

00101189 48 83 ec 10

| | |
|---|---|
| | CF = INT_LESS RSP, 16:8 |
| | OF = INT_SBORROW RSP, 16:8 |
| | RSP = INT_SUB RSP, 16:8 |
| | SF = INT_SLESS RSP, 0:8 |
| | ZF = INT_EQUAL RSP, 0:8 |
| | $U13180:8 = INT_AND RSP, 0xff:8 |
| | $U13200:1 = POPCOUNT $U13180:8 |
| | $U13280:1 = INT_AND $U13200:1, 1:1 |
| | PF = INT_EQUAL $U13280:1, 0:1 |
| 0010118d 48 8d 05 | = “Start IDA |

Tracing”
75 0e 00 00

| | |
|---|---|
| | RAX = COPY 0x102009:8 |
| 00101194 48 89 c7 | = “Start IDA |

Tracing”

| | |
|---|---|
| | RDI = COPY RAX |
| 00101197 e8 94 fe | int puts(char * |

_{——}s)
ff ff

```
  RSP = INT_SUB RSP, 8:8
  STORE ram(RSP) , 0x10119c:8
  CALL *[ram] 0x101030:8
```

```
    0010119c c7 45 fc
          02 00 00 00
```

```
  $U3100:8 = INT_ADD RBP, −4:8
  $Ubf80:4 = COPY 2:4
  STORE ram($U3100:8), $Ubf80:4
```

001011a3 8b 45 fc

```
  $U3100:8 = INT_ADD RBP, −4:8
  $Ubf00:4 = LOAD ram($U3100:8)
  EAX = COPY $Ubf00:4
  RAX = INT_ZEXT EAX
```

001011a6 89 c7

| | |
|---|---|
| | EDI = COPY EAX |
| | RDI = INT_ZEXT EDI |
| 001011a8 e8 9c ff | undefined loop( ) |

ff ff

```
  RSP = INT_SUB RSP, 8:8
  STORE ram(RSP), 0x1011ad:8
  CALL *[ram]0x101149:8
```

001011ad 89 45 f8

| | |
|---|---|
| | $U3100:8 = INT_ADD RBP, −8:8 |
| | $Ubf00:4 = COPY EAX |
| | STORE ram($U3100:8), $Ubf00:4 |
| 001011b0 48 8d 05 | = “Stop IDA |

Tracing”
64 0e 00 00

| | |
|---|---|
| | RAX = COPY 0x10201b:8 |
| 001011b7 48 89 c7 | = “Stop IDA |

Tracing”

| | |
|---|---|
| | RDI = COPY RAX |
| 001011ba e8 71 fe | int puts(char * |

_{——}s)
ff ff

```
  RSP = INT_SUB RSP, 8:8
  STORE ram(RSP), 0x1011bf:8
  CALL *[ram] 0x101030:8
```

```
    001011bf b8 00 00
          00 00
```

RAX = COPY 0:8

001011c4 c9

```
  RSP = COPY RBP
  RBP = LOAD ram(RSP)
  RSP = INT_ADD RSP, 8:8
```

001011c5 c3

```
  RIP = LOAD ram(RSP)
  RSP = INT_ADD RSP, 8:8
  RETURN RIP
```

A string kernel search can now be applied to the intermediate representation 203, as described, for example, in Reference 1.

One or more strings are generated from the intermediate representation 203, for example via an intermediate step (grouping a plurality of characters into “tokens,” i.e. the strings are then chains of such tokens, which in turn are (short) character strings).

If the program to be examined and the program database 205 are each given in string form, the string kernel search looks for the longest strings that are contained both in the program to be examined and in the program database 205.

The number of such common substrings between the program to be examined and a program component in string form in the program database 205 can be used as a similarity measure and then it is possible to determine (e.g. by means of a comparison with a threshold value) whether the program component is contained in the program to be examined or not.

In this case, tokens can be assigned weights and the parameter “cut weight” specifies the minimum weight that such common substrings must have to be taken into account.

The search is carried out, for example, for each program code segment, i.e., for each program code segment identified in the lifted binary code 202 or in the intermediate representation 203, a similarity to program code segments that are stored in the program database 205 in string form is ascertained and, depending on the similarity, a decision is made as to whether this program component (as a program code segment) is contained in the program to be examined or not.

The intermediate representation code strings from the sequence of intermediate representation instructions can be generated at least in part by compensating for obfuscation techniques. For example, the strings can be generated in a special way by reversing or taking into account obfuscation techniques, so that even obfuscated (sub) sequences of intermediate representation instructions can be assigned to the reference intermediate representation code strings (and thus to the associated program components).

The following table shows an example of this in intermediate representation code.

| Original code | Obfuscated code |
|---|---|
| .model small | .model small |
| .code | .code |
| Mov AH, 2 | Mov AH, 2 |
| Mov DL, 65 | Mov DL, 65 |
| Mov BL, 70 | Mov BL, 70 |
| L1: Int 21h | L1: Int 21h |
| Add DL, 1 | Add DL, 1 |
| Cmp DL, BL | Add BL, 185 |
| JLE L1 | JNC L1 |
| Mov AH, 76 | Mov AH, 76 |
| Int 21h | Int 21h |
| end | end |

Although the obfuscated code is different from the original code, the approach described above can find it because the string kernel search does not search for code one-to-one, but looks at similarities.

For example, the strings could be generated in such a way that the tokens are not mnemonics (in this case, for example, JLE and JNC), but classes of commands (in this case, for example, the class “Jump”).

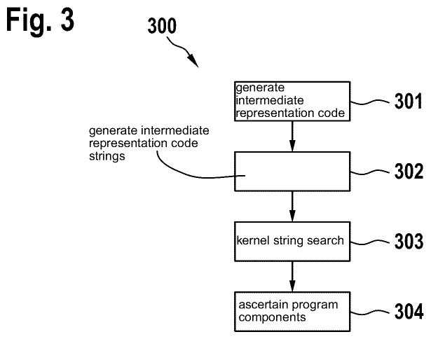

In summary, according to various embodiments, a method is provided as shown in FIG. 3.

FIG. 3 shows a flow chart 300 that illustrates a method for automatically analyzing a computer program (i.e., in particular, ascertaining the program components present in a computer program (to be examined, which computer program is present in a compiled version, i.e. binary code)) according to one embodiment.

In 301, intermediate representation code with a sequence of intermediate representation instructions is generated by decompiling binary code of the computer program (to be examined). The intermediate representation code can, for example, be generated from the binary code by first decompiling it into assembly instructions and then generating the intermediate representation code (e.g. p-code) by means of binary lifting.

In 302, one or more intermediate representation code strings are generated from the sequence of intermediate representation instructions. This is done, for example, by generating a control flow graph (call graph) and, based on this, generating tokens (e.g. one token per node of the control flow graph) and generating intermediate representation code strings from the tokens.

In 303, a string kernel search is performed in the one or more intermediate representation code strings for reference intermediate representation code strings of a plurality of reference intermediate representation code strings (from a database), wherein each reference intermediate representation code string belongs to a program component (e.g. a function but possibly also a larger (sub) program).

In 304, the program components to which the reference intermediate representation code strings found in the one or more intermediate representation code strings by means of the string kernel comparison belong are ascertained as the program components present in the computer program.

The method in FIG. 3 can be carried out by one or more computers with one or more data processing units. The term “data processing unit” may be understood as any type of entity that enables processing of data or signals. The data or signals can be treated, for example, according to at least one (i.e. one or more than one) special function which is performed by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the respective functions described in more detail herein may also be understood as a data processing unit or logic circuit assembly. One or more of the method steps described in detail here can be executed (e.g. implemented) by a data processing unit by one or more special functions that are performed by the data processing unit.

The method is in particular computer-implemented according to various embodiments.

The approach of FIG. 3 is used to analyze a program (e.g. with respect to vulnerabilities), for example control software for a robot device. The term “robot device” may be understood to refer to any technical system, such as a computer-controlled machine, a vehicle, a household appliance, a power tool, a production machine, a personal assistant or an access control system. The control software can also be used for data-processing systems, such as a navigation device.

The method of FIG. 3 is carried out, for example, by a test arrangement (e.g. the computer 100 and target device 106 in FIG. 1).

What is claimed is:

1. A method for automatically analyzing a computer program, the method comprising the following steps:
generating intermediate representation code including a sequence of intermediate representation instructions by decompiling binary code of the computer program;
generating one or more intermediate representation code strings from the sequence of intermediate representation instructions;
searching for reference intermediate representation code strings of a plurality of reference intermediate representation code strings in the one or more intermediate representation code strings using a string kernel search, wherein each reference intermediate representation code string belongs to a program component; and
ascertaining the program components to which the reference intermediate representation code strings, found in the one or more intermediate representation code strings by the string kernel search, belong as the program components present in the computer program.

2. The method according to claim 1, wherein the one or more intermediate representation code strings are a plurality of intermediate representation code strings generated by combining subsequences of the sequence of intermediate representation instructions into program code segments which each form a function, and wherein the reference intermediate representation code strings are searched for in each intermediate representation code string.

3. The method according to claim 1, further comprising:
ascertaining security gaps in the computer program based on the ascertained program components and information regarding security gaps in the ascertained program components.

4. The method according to claim 1, wherein the one or more intermediate representation code strings are generated from the sequence of intermediate representation instructions at least partially by compensating for or taking into account obfuscation techniques.

5. The method according to claim 1, comprising ascertaining program components missing in the computer program (105) on the basis of the program components ascertained to be present in the computer program.

6. The method according to claim 1, further comprising:
controlling a robot device including the computer program depending on whether the program components ascertained to be present in the computer program correspond to a predetermined set of required and/or permissible program components.

7. A software analysis system configured to automatically analyze a computer program, the system configured to:
generate intermediate representation code including a sequence of intermediate representation instructions by decompiling binary code of the computer program;
generate one or more intermediate representation code strings from the sequence of intermediate representation instructions;
search for reference intermediate representation code strings of a plurality of reference intermediate representation code strings in the one or more intermediate representation code strings using a string kernel search, wherein each reference intermediate representation code string belongs to a program component; and
ascertain the program components to which the reference intermediate representation code strings, found in the one or more intermediate representation code strings by the string kernel search, belong as the program components present in the computer program.

8. A non-transitory computer-readable medium on which are stored instructions for automatically analyzing a computer program, the instructions, when executed by a processor, causing the processor to perform the following steps:
generating intermediate representation code including a sequence of intermediate representation instructions by decompiling binary code of the computer program;
generating one or more intermediate representation code strings from the sequence of intermediate representation instructions;
searching for reference intermediate representation code strings of a plurality of reference intermediate representation code strings in the one or more intermediate representation code strings using a string kernel search, wherein each reference intermediate representation code string belongs to a program component; and
ascertaining the program components to which the reference intermediate representation code strings, found in the one or more intermediate representation code strings by the string kernel search, belong as the program components present in the computer program.
